(19) United States
(12) Patent Application Publication
(10) Pub. No.: US 2024/0150178 A1
(43) Pub. Date: May 9, 2024

(54) POROUS CARBON MATERIAL, METHOD FOR PREPARING THE SAME, ELECTRODE COMPRISING THE SAME, AND LITHIUM-SULFUR BATTERY

(71) Applicant: LG Energy Solution, Ltd., Seoul (KR)

(72) Inventors: Myeongjun Song, Daejeon (KR); Intae Park, Daejeon (KR); Ran Choi, Daejeon (KR); Hyunsoo Lee, Daejeon (KR); Yonghwi Kim, Daejeon (KR); Seonghyo Park, Daejeon (KR); Seungbo Yang, Daejeon (KR)

(21) Appl. No.: 18/281,236

(22) PCT Filed: Nov. 24, 2022
(86) PCT No.: PCT/KR2022/018700

§ 371 Date: Sep. 8, 2023

(30) Foreign Application Priority Data
Dec. 16, 2021 (KR) 10-2021-0180557
Nov. 15, 2022 (KR) 10-2022-0152348

(51) Int. Cl. C01B 32/05; H01M 4/583; H01M 10/052; H01M 10/0568; H01M 10/0569

(52) U.S. Cl. CPC C01B 32/05; H01M 4/583; H01M 10/052; H01M 10/0568; H01M 10/0569; C01P 2002/08; C01P 2002/88; C01P 2006/12; C01P 2006/40; H01M 2004/021; H01M 2300/0034; H01M 2300/0037

(57) ABSTRACT

A porous carbon material, a method for preparing the same, a positive electrode including the same, and a lithium-sulfur battery including the same are provided. The porous carbon material has a specific surface area of 200 to 1,700 m²/g and impurities therefrom are removed through pre-treatment using microwaves. The porous carbon material, when applied to the positive electrode of the lithium-sulfur battery, improves the charging overvoltage problem of the lithium-sulfur battery.

### CROSS-REFERENCE TO RELATED APPLICATION(S)

The present application is a National Stage Application of International Application No. PCT/KR2022/018700, filed on Nov. 24, 2022, which claims the benefits of priorities based on Korean Patent Application No. 10-2021-0180557 filed on Dec. 16, 2021 and Korean Patent Application No. 10-2022-0152348 filed on Nov. 15, 2022, the disclosures of which are incorporated herein by reference in their entireties.

### FIELD

The present disclosure relates to a porous carbon material from which impurities have been removed, its preparation method, a positive electrode of a lithium-sulfur battery comprising the porous carbon material as a positive electrode active material, and a lithium-sulfur battery, and more particularly to a porous carbon material from which impurities such as moisture have been removed through pre-treatment, the porous carbon material capable of improving charging overvoltage problem of a lithium-sulfur battery when applied to a positive electrode of the lithium-sulfur battery, and its preparation method, a positive electrode of a lithium-sulfur battery comprising the porous carbon material as a positive electrode active material, and a lithium-sulfur battery.

### BACKGROUND

As interest in energy storage technology continues to increase, since its application is expanding from energy for mobile phones, tablets, laptops, and camcorders to even energy for electric vehicles (EVs) and hybrid electric vehicles (HEVs), research and development of electrochemical devices are gradually increasing. The field of electrochemical devices is an area that is receiving the most attention in this respect. Among them, development of secondary batteries such as a lithium-sulfur battery capable of being charged/discharged has become a focus of attention. In recent years, in developing these batteries, in order to improve capacity density and specific energy, it has led to research and development in designs for new electrodes and batteries.

Among these electrochemical devices, a lithium-sulfur battery (Li—S battery) has a high energy density (theoretical capacity) and thus is in the spotlight as a next-generation secondary battery that can replace a lithium-ion battery. In such a lithium-sulfur battery, a reduction reaction of sulfur and an oxidation reaction of lithium metal occur during discharging. In this case, sulfur forms lithium polysulfide (LiPS) having a linear structure from Ss having a ring structure. This lithium-sulfur battery is characterized by showing a stepwise discharging voltage until the polysulfide is completely reduced to Li₂S.

However, the biggest obstacle of the lithium-sulfur battery in commercialization is lifetime of the battery, which is deteriorated as charging/discharging efficiency is reduced during charging/discharging process. There are various reasons for deterioration of the lifetime of the lithium-sulfur battery, such as side reactions of electrolytes (sedimentation of by-products following decomposition of electrolyte), instability of lithium metal (dendrite grows on the lithium negative electrode, resulting in a short circuit), and sedimentation of by-products from the positive electrode (leaching of the lithium polysulfide from the positive electrode).

That is, in a battery using a sulfur-based compound as a positive electrode active material and an alkali metal such as lithium as a negative electrode active material, leaching and shuttle phenomena of lithium polysulfide are occurred during the charging/discharging, and the lithium polysulfide is transferred to the negative electrode, reducing the capacity of the lithium-sulfur battery, and as a result, there is a big problem that the lithium-sulfur battery has a reduced lifetime and reduced reactivity. That is, since the polysulfide leached from the positive electrode has a high solubility in the organic electrolyte, unwanted movement (PS shuttling) may occur toward the negative electrode through the electrolyte, and as a result, a decrease in capacity due to irreversible loss of the positive electrode active material and a decrease in the lifetime of the battery due to deposition of sulfur particles on the surface of lithium metal due to side reactions are occurred.

Meanwhile, in order to build a lithium-sulfur battery with a high energy density of about 400 Wh/kg or more or 600 Wh/L or more, an electrolyte and positive electrode active material system that can operate even under conditions of high loading (about 4.0 mAh/cm² or more) and low porosity (about 60% or less) is required. That is, the behavior of such a lithium-sulfur battery may vary greatly depending on the electrolyte. The electrolyte when sulfur in the positive electrode is leached into the electrolyte in the form of lithium polysulfide (LiPS) is called catholyte and the electrolyte when sulfur hardly leaches out in the form of lithium polysulfide is called sparingly solvating electrolyte (SSE). Since the lithium-sulfur battery utilizing the existing catholyte system is dependent on the liquid phase reaction through the production of an intermediate product (intermediate polysulfide) in the form of Li₂Sₓ (catholyte type), there is a problem that it does not fully utilize ‘high theoretical discharging capacity (1,675 mAh/g) of sulfur, and rather, the lifetime of the battery is drastically reduced by the degradation of the battery due to leaching of polysulfide.

On the other hand, recently, it was confirmed that a sparingly solvating electrolyte (SSE) electrolyte system that can suppress the leaching of polysulfide has been developed, and thus 90% or more of sulfur's theoretical discharging capacity can be utilized, especially when a carbon material with a high specific surface area (BET) of 200 to 1,700 m²/g is applied as a support for sulfur. However, in the case of this carbon material, there is a problem that since it contains a relatively large amount of impurities such as moisture due to its high specific surface area, the side reaction of the electrode is increased, causing a charging overvoltage phenomenon and thus the availability is lowered. In order to solve this problem, in the art, the carbon material with a high specific surface area is heat-treated in a furnace, but in this case, the time required is long and it is difficult to effectively remove the impurities.

Accordingly, even when the SSE electrolyte system is used, there is a need for a method to improve the charging overvoltage problem by effectively removing impurities such as moisture contained in the carbon material with a high specific surface area.

### SUMMARY

Therefore, it is an object of the present disclosure to provide a porous carbon material from which impurities such as moisture have been removed through pre-treatment, which can improve the charging overvoltage problem when applied to a positive electrode for a lithium-sulfur battery, preparation method thereof, a positive electrode for a lithium-sulfur battery comprising the porous carbon material as a positive electrode active material, and a lithium-sulfur battery.

In order to achieve the above object, the present disclosure provides a porous carbon material having a specific surface area of 200 to 1,700 m²/g, from which impurities have been removed through pre-treatment using microwaves.

In addition, the present disclosure provides a method for preparing a porous carbon material from which impurities have been removed, of the method comprising: (a) putting a porous carbon material having a specific surface area of 200 to 1,700 m²/g into an airtight container, and then purging the airtight container with an inert gas by injecting the inert gas; and (b) applying microwaves to the porous carbon material.

In addition, the present disclosure provides a positive electrode for a lithium-sulfur battery comprising, as a positive electrode active material, a sulfur-carbon composite formed by supporting sulfur in the porous carbon material from which impurities have been removed.

In addition, the present disclosure provides a lithium-sulfur battery comprising the positive electrode as described above; a negative electrode; a separator between the positive electrode and the negative electrode; and an electrolyte comprising a first solvent containing a fluorine-based ether compound, a second solvent containing a glyme-based compound, and a lithium salt.

According to the porous carbon material from which impurities such as moisture have been removed, preparation method thereof, the positive electrode for the lithium-sulfur battery comprising the porous carbon material as a positive electrode active material, and the lithium-sulfur battery of the present disclosure, the charging overvoltage problem of the battery can be improved by applying the porous carbon material, from which impurities have been removed through pre-treatment, to the positive electrode. In addition, by applying a positive electrode for a lithium-sulfur battery containing the impurity-removed porous carbon material described above as a positive electrode active material, with a sparingly solvating electrolyte (SSE) electrolyte system (discharging capacity ˜1,600 mAh/g) rather than an existing catholyte electrolyte system (discharging capacity: ˜1,200 mAh/g), there is an advantage that the discharging capacity of sulfur (1,675 mAh/g) can be utilized by 90% or more and the energy density is also kept high at about 400 Wh/kg or more or 600 Wh/L or more.

### BRIEF DESCRIPTION OF DRAWINGS

FIG. 1 is a graph of TGA analysis for checking whether impurities are removed from the porous carbon materials according to an embodiment of the present disclosure and a comparative example.

FIG. 2 is a graph showing the temperature profile over time when irradiating microwaves under the same conditions on porous carbon material and sulfur-carbon composite.

FIG. 3 is a graph of TGA analysis showing the degree of the decrease in weight due to temperature increase by performing TGA analysis on a porous carbon material according to an embodiment of the present disclosure and a sulfur-carbon composite according to a comparative example.

### DETAILED DESCRIPTION

Hereinafter, the present disclosure will be described in detail.

The porous carbon material according to the present disclosure is characterized in that the specific surface area thereof is 200 to 1,700 m²/g and the impurities therefrom have been removed through pre-treatment using microwaves.

In order to build a lithium-sulfur battery with a high energy density of about 400 Wh/kg or more or 600 Wh/L or more, an electrolyte and positive electrode active material system that can operate even under conditions of high loading (about 4.0 mAh/cm² or more) and low porosity (about 60% or less) is required. In addition, as such an electrolyte system, a sparingly solvating electrolyte (SSE) electrolyte system has been developed that complements the problem of the electrolyte when sulfur from the positive electrode is leached into the electrolyte in the form of lithium polysulfide (LiPS) (i.e., which can inhibit the leaching of polysulfide). In addition, particularly, it was confirmed that when a carbon material with a high specific surface area (BET) of 200 to 1,700 m²/g is applied to the positive electrode active material as a sulfur carrier and grafted to the SSE electrolyte system, 90% or more of the theoretical discharging capacity of sulfur can be utilized (That is, a utilization rate of sulfur is 90% or more. The ‘utilization rate of sulfur’ is specifically the ratio of discharging capacity (mAh) per weight (gram) of elemental sulfur comprised in the positive electrode of the battery to 1,675 mAh/g, which is the theoretical capacity per weight of sulfur. For example, when the discharging capacity per weight of elemental sulfur present in the positive electrode of the lithium-sulfur battery is 1,600 mAh/g, the utilization rate of sulfur is 95.5% (1,600/1,675)).

However, in the case of this carbon material, there is a problem that since it also contains a relatively large amount of impurities such as moisture (specifically, other impurities such as moisture contained in the carbon material and unnecessary functional groups present in the inside and on the surface of the carbon material) due to its high specific surface area, the side reaction of the electrode is increased, causing a charging overvoltage phenomenon and thus the availability is lowered. In order to solve this problem, in the art, the carbon material with a high specific surface area is heat-treated in a furnace, but in this case, the time required is long and it is difficult to effectively remove the impurities.

Accordingly, the present applicant has increased the availability of a carbon material having a high specific surface area, by effectively removing impurities such as moisture contained in the carbon material with a high specific surface area through pre-treatment using microwaves, even while using the SSE electrolyte system. In addition, the present applicant made it possible to prepare a uniform positive electrode active material by improving the ability of the carbon material to support sulfur, thereby improving the charging overvoltage problem.

As in the present disclosure, if pretreatment is performed by applying (or irradiating) microwaves to a porous carbon material having a high specific surface area, rapid heating and stopping are possible due to energy transfer rather than conventional heat transfer. Particularly, there is an advantage that since the yield of converting the energy incident to the porous carbon material into thermal energy is high, the efficiency is higher than that of conventional ones, for example, the time required to remove impurities is short, and so on.

Meanwhile, although the present disclosure is to remove the impurities contained in the carbon material by applying microwaves to the porous carbon material, if the microwaves are applied in a state in which the porous carbon material and another material (for example, sulfur) are combined, it is impossible to selectively remove the impurities contained in the carbon material. For example, if the microwaves are applied to a sulfur-carbon composite in which the porous carbon material and sulfur are combined, it is impossible to remove only the impurities contained in the carbon material because even sulfur is vaporized and volatilized. This is because, when the microwaves are applied, the rate of increase in the temperature of carbon is faster than that of sulfur, and the energy generated when the temperature of carbon rises is transferred to the surrounding sulfur, and at this time, sulfur is vaporized from a lower temperature before the impurities contained in carbon are removed.

The porous carbon material according to the present disclosure is characterized in that the specific surface area is 200 to 1,700 m²/g and the impurities are removed through pre-treatment using microwaves, as described above. If the porous carbon material is used in fields other than batteries, there is no particular limitation as long as the impurities are removed by pre-treatment using microwaves even if the specific surface area is out of the above range. However, in the lithium-sulfur battery using the SSE electrolyte system to utilize 90% or more of the theoretical discharging capacity of sulfur, the performance of the battery can be maximized only when the carbon material having the specific surface area within the above range is used. In addition, a pore volume of the porous carbon material may be 1.5 cm³/g or more. If the pore volume of the porous carbon material is less than 1.5 cm³/g, it may be difficult to implement a battery having a high energy density due to a decrease in the amount of sulfur supported.

In addition, the related carbon material to which the microwaves are applied may be, for example, carbon nanotubes; graphene (in particular, multilayer graphene flake, MGF); graphite; carbon black, such as carbon black, acetylene black, Ketjen black, Denka black, thermal black, channel black, furnace black, lamp black, etc.; carbon fiber; or a mixture containing two or more thereof.

In addition, the pre-treatment using the microwaves is characterized in that the microwaves are applied to the porous carbon material under a condition that MPPT according to the following Equation 1 is 2,000 to 10,000 W·s/g.

MPPT(W·s/g)=Microwave Power(W)×Time(s)/Weight of carbon material(g) [Equation 1]

wherein Time is a period of time in seconds during which the microwaves are applied, and is longer than 10 seconds. In addition, the porous carbon material is preferably in the form of a powder.

However, the MPPT (W·s/g) value of Equation 1 above may also be different because each of the carbon materials before the microwaves were applied is different in the content of other impurities such as moisture and functional groups, except for carbon.

In one embodiment, the MPPT value of the carbon nanotubes is 2,000 to 10,000 W·s/g, but when it exceeds about 2,800 W·s/g, there may be no practical benefit because the impurities are no longer removed. In addition, if the MPPT value of the carbon nanotubes is less than 2,000 W·s/g, it is impossible or insufficient to remove the impurities, and thus it is difficult to achieve the object of the present disclosure for the purpose of improving the charging overvoltage. If the MPPT value of the carbon nanotubes exceeds 10,000 W·s/g, it may lead to ignition.

The MPPT value of the graphene (in particular, multilayer graphene flake, MGF) is also 2,000 to 10,000 W·s/g. However, if it exceeds about 5,300 W·s/g, there may be no practical benefit because the impurities are no longer removed. In addition, if the MPPT value of the graphene is less than 2,000 W·s/g, it is impossible or insufficient to remove the impurities, and thus it is difficult to achieve the object of the present disclosure for the purpose of improving the charging overvoltage. If the MPPT value of the graphene exceeds 10,000 W·s/g, it may lead to ignition.

The MPPT value of the carbon black is also 2,000 to 10,000 W·s/g. However, if it exceeds about 3,500 W·s/g, there may be no practical benefit because the impurities are no longer removed. In addition, if the MPPT value of the carbon black is less than 2,000 W·s/g, it is impossible or insufficient to remove the impurities, and thus it is difficult to achieve the object of the present disclosure for the purpose of improving the charging overvoltage. If the MPPT value of the carbon black exceeds 10,000 W·s/g, it may lead to ignition.

The MPPT value of the Ketjen black is also 2,000 to 10,000 W·s/g, preferably 5,000 to 9,900 W·s/g. If it exceeds 9,900 W·s/g, there may be no practical benefit because the impurities are no longer removed. In addition, if the MPPT value of the Ketjen black is less than 2,000 W·s/g, it is impossible or insufficient to remove the impurities, and thus it is difficult to achieve the object of the present disclosure for the purpose of improving the charging overvoltage. If the MPPT value of the Ketjen black exceeds 10,000 W·s/g, it may lead to ignition. Accordingly, when applying the microwaves to the carbon material, microwave energy must be applied according to the range of MPPT corresponding to each carbon material.

The porous carbon material having the specific surface area and pore volume as described above and to which microwaves have been applied is characterized in that 90 to 100%, preferably 99 to 100%, of the total impurities contained therein have been removed. The impurities comprise moisture, and specifically, comprise moisture contained in the porous carbon material and other impurities such as unnecessary functional groups present in an inside and on a surface of the porous carbon material. Meanwhile, even if the impurities are removed by applying the microwaves to the carbon material having a high specific surface area as described above, it can be said that the reabsorption of moisture during storage is inevitable.

Meanwhile, if the pre-treatment using the microwaves is performed on the porous carbon material having a high specific surface area as in the present disclosure (that is, in other words, if only the carbon material is processed by the microwaves before manufacturing the sulfur-carbon composite included in the positive electrode active material of the lithium-sulfur battery), the lithium-sulfur battery can control the content of sulfur participating in the actual reaction during operation more quickly and accurately than the existing ones. For example, if sulfur and a carbon material that has not been subjected to microwave pre-treatment are mixed in a weight ratio of 70:30, and the impurities are contained in the carbon material at a content of 5% by weight, the actual weight ratio of sulfur to the carbon material is 70:28.5 (i.e., 70:(30×0.95)). That is, the discharging capacity of the lithium-sulfur battery is calculated based on the content of sulfur contained in the battery. Accordingly, if the pre-treatment using the microwaves is performed on the carbon material having a high specific surface area as in the present disclosure, the content of sulfur and the carbon material contained in the positive electrode active material can be more accurately identified. That is, in other words, there is no impurities in the porous carbon material, and thus there is no error in a content of sulfur contained in the positive electrode active material and the carbon material.

Next, the method for preparing the porous carbon material from which impurities have been removed as described above will be described. The method for preparing the porous carbon material from which impurities have been removed comprises: (a) putting a porous carbon material having a specific surface area of 200 to 1,700 m²/g into an airtight container, and then purging by injecting an inert gas and (b) applying microwaves to the porous carbon material.

As the airtight container, a typical container that is sealed and capable of being purged even when an inert gas is injected, such as a glass jar, may be exemplified. In addition, the inert gas is a general inert gas such as nitrogen (N2), and there is no particular limitation on injection conditions of the inert gas. In addition, step (b) is characterized in that the microwaves are applied to the porous carbon material under a condition that MPPT according to the following Equation 1 is 2,000 to 10,000 W·s/g.

MPPT(W·s/g)=Microwave Power(W)×Time(s)/Weight of carbon material(g) [Equation 1]

wherein, Time is a period of time in seconds during which the microwaves are applied, and is longer than 10 seconds. In addition, the porous carbon material is preferably in the form of a powder.

However, the MPPT (W·s/g) value of Equation 1 above may also be different because each of the carbon materials before the microwaves were applied is different in the content of other impurities such as moisture and functional groups, except for carbon. Descriptions regarding these are replaced with those described above as an embodiment.

Subsequently, the positive electrode for the lithium-sulfur battery according to the present disclosure will be described. The positive electrode for the lithium-sulfur battery comprises, as a positive electrode active material, a sulfur-carbon composite in which sulfur is supported in the porous carbon material from which the impurities have been removed.

The positive electrode for the lithium-sulfur battery comprises a positive electrode active material, a binder, and a conductive material. In addition, the positive electrode active material may comprise elemental sulfur (S₈), a sulfur-based compound, or a mixture thereof, in addition to the porous carbon material from which impurities have been removed, as described above, and the sulfur-based compound may specifically comprise Li₂Sₙ(n>1), or an organic sulfur compound, etc. In addition, as described above, it is preferable to use, as a positive electrode active material, sulfur-carbon composites ((C₂Sₓ)ₙ: x=2.5˜50, n>2) containing (compositing) a porous carbon material from which impurities have been removed and sulfur.

The sulfur-carbon composites may have a particle size of 1 to 100 μm. If the size of the particles of the sulfur-carbon composite is less than 1 μm, the resistance between the particles is increased, and thus the overvoltage may occur at the electrode of the lithium-sulfur battery. If the size of the particles exceeds 100 μm, since the surface area per unit weight is reduced, the wetting area with the electrolyte in the electrode and the reaction site with lithium ions are reduced, and since the amount of electrons transferred relative to the size of the composite is reduced, the reaction may be delayed, and thus the discharge capacity of the battery may be reduced.

Sulfur (S) may be contained in an amount of 60 to 90% by weight, preferably 65 to 85% by weight, and more preferably 65 to 80% by weight, based on the total weight of the positive electrode active material. If sulfur is used in an amount of less than 60% by weight based on the total weight of the positive electrode, there may be a problem that an energy density of the battery is decreased. If sulfur is used in an amount exceeding 90% by weight, there may be a problem that the conductivity in the electrode is lowered and the stability of the electrode is lowered.

The positive electrode active material containing sulfur and the carbon material as described above may be contained in an amount of 80 to 99 parts by weight, preferably 90 to 95 parts by weight, based on 100 parts by weight of the total weight of the positive electrode. If the content of the positive electrode active material is less than 80 parts by weight based on 100 parts by weight of the total weight of the positive electrode, there may be a problem that an energy density of the battery is decreased. If the content of the positive electrode active material exceeds 99 parts by weight, there may be a problem that the conductivity in the electrode is lowered and the stability of the electrode is lowered.

The binder is a component that assists in the bonding between a positive electrode active material and an electrically conductive material and the bonding to a current collector, and for example, may be, but is not limited to, at least one selected from the group consisting of polyvinylidenefluoride (PVdF), polyvinylidenefluoride-polyhexafluoropropylene copolymer (PVdF/HFP), polyvinylacetate, polyvinylalcohol, polyvinylether, polyethylene, polyethyleneoxide, alkylated polyethyleneoxide, polypropylene, polymethyl(meth)acrylate, polyethyl(meth)acrylate, polytetrafluoroethylene (PTFE), polyvinylchloride, polyacrylonitrile, polyvinylpyridine, polyvinylpyrrolidone, styrene-butadiene rubber, acrylonitrile-butadiene rubber, ethylene-propylene-diene monomer (EPDM) rubber, sulfonated EPDM rubber, styrene-butylene rubber, fluorine rubber, carboxymethylcellulose (CMC), starch, hydroxypropyl cellulose, regenerated cellulose, and mixtures thereof.

The binder is usually added in an amount of 1 to 50 parts by weight, preferably—to 15 parts by weight, based on 100 parts by weight of the total weight of the positive electrode. If the content of the binder is less than 1 part by weight, the adhesive strength between the positive electrode active material and the current collector may be insufficient. If the content of the binder exceeds 50 parts by weight, the adhesive strength is improved but the content of the positive electrode active material may be reduced, thereby lowering the capacity of the battery.

The electrically conductive material comprised in the positive electrode is not particularly limited as long as it has excellent electrical conductivity without causing side reactions in the internal environment of the battery and causing chemical changes in the battery. As the electrically conductive material, graphite or electrically conductive carbon may be used, and for example, one selected from the group consisting of graphite such as natural graphite or artificial graphite; carbon black such as carbon black, acetylene black, Ketjen black, Denka black, thermal black, channel black, furnace black, lamp black, etc.; carbon-based materials whose crystal structure is graphene or graphite; carbon nanotubes; electrically conductive fibers such as carbon fibers and metal fibers; carbon fluoride; metal powders such as aluminum and nickel powder; electrically conductive whiskers such as zinc oxide and potassium titanate; electrically conductive oxides such as titanium oxide; electrically conductive polymers such as polyphenylene derivatives may be typically used alone or in combination of two or more, but are not necessarily limited thereto.

The electrically conductive material may be added in an amount of 0.5 to 10 parts by weight, preferably 0.5 to 5 parts by weight based on 100 parts by weight of the total weight of the positive electrode, but may not be included in the positive electrode of the present disclosure. If the content of the electrically conductive material exceeds 10 parts by weight, that is, if it is too much, the amount of the positive electrode material is relatively small, and thus the capacity and the energy density may be lowered. The method of incorporating the electrically conductive material into the positive electrode is not particularly limited, and conventional methods known in the related art such as coating on the positive electrode active material can be used. Also, if necessary, the addition of the second coating layer with electrical conductivity to the positive electrode material may replace the addition of the electrically conductive material as described above.

In addition, a filler may be selectively added to the positive electrode of the present disclosure as a component for inhibiting the expansion of the positive electrode. Such a filler is not particularly limited as long as it can inhibit the expansion of the electrode without causing chemical changes in the battery, and examples thereof may comprise olefinic polymers such as polyethylene and polypropylene; fibrous materials such as glass fibers and carbon fibers.

The positive electrode active material, the binder, the electrically conductive material, and the like are dispersed and mixed in a dispersion medium (solvent) to form a slurry, and the slurry can be applied onto the positive electrode current collector, followed by drying and rolling it to prepare a positive electrode. The dispersion medium may be, but is not limited to, N-methyl-2-pyrrolidone (NMP), dimethyl formamide (DMF), dimethyl sulfoxide (DMSO), ethanol, isopropanol, water, and a mixture thereof.

The positive electrode current collector may be, but is not necessarily limited to, platinum (Pt), gold (Au), palladium (Pd), iridium (Ir), silver (Ag), ruthenium (Ru), nickel (Ni), stainless steel (STS), aluminum (Al), molybdenum (Mo), chromium (Cr), carbon (C), titanium (Ti), tungsten (W), ITO (In doped SnO₂), FTO (F doped SnO₂), or an alloy thereof, or aluminum (Al) or stainless steel whose surface is treated with carbon (C), nickel (Ni), titanium (Ti) or silver (Ag) or so on. The shape of the positive electrode current collector may be in the form of a foil, film, sheet, punched form, porous body, foam or the like.

Finally, the lithium-sulfur battery according to the present disclosure will be described. The lithium-sulfur battery comprises the positive electrode for the lithium-sulfur battery as described above, a negative electrode, a separator between the positive electrode and the negative electrode, and an electrolyte comprising a first solvent containing a fluorine-based ether compound, a second solvent containing a glyme-based compound and a lithium salt.

The lithium-sulfur battery of the present disclosure uses a sparingly solvating electrolyte (SSE) electrolyte system, but comprises, as a positive electrode active material, a porous carbon material with a high specific surface area (BET) of 200 to 1,700 m²/g and from which impurities have been removed by applying microwaves, and has a high energy density of about 400 Wh/kg or more or 600 Wh/L or more, while being able to utilize more than 90%, preferably 94 to 100% of the theoretical discharging capacity of sulfur.

Hereinafter, each of the first solvent containing a fluorine-based ether compound, the second solvent containing a glyme-based compound and the lithium salt contained in the electrolyte of the lithium-sulfur battery according to the present disclosure will be described in detail.

The first solvent is an electrolyte solvent containing a fluorine-based ether compound, and has an effect of inhibiting dissolution of polysulfide and decomposition of the solvent, thereby improving the coulombic efficiency (C.E.) of the battery and ultimately playing a role in improving the lifetime of the battery. More specifically, the first solvent containing a fluorine-based ether compound has excellent structural stability due to fluorine substitution compared to general organic solvents containing alkanes, and thus has very high stability. Accordingly, if this is used in the electrolyte solution of the lithium-sulfur battery, the stability of the electrolyte solution can be greatly improved, thereby improving the lifetime performance of the lithium-sulfur battery.

Examples of the fluorine-based ether compound may be at least one hydrofluoro ether-based (HFE type) compound selected from the group consisting of 1,1,2,2-tetrafluoroethyl 2,2,3,3-tetrafluoropropyl ether (TTE), bis(fluoromethyl) ether, 2-fluoromethyl ether, bis(2,2,2-trifluoroethyl) ether, propyl 1,1,2,2-tetrafluoroethyl ether, isopropyl 1,1,2,2-tetrafluoroethyl ether, 1,1,2,2-tetrafluoroethyl isobutyl ether, 1,1,2,3,3,3-hexafluoropropylethyl ether, 1H,1H,2′H,3H-decafluorodipropyl ether and 1H,1H,2′H-perfluorodipropyl ether.

The second solvent is an electrolyte solvent containing a glyme-based compound (but not containing fluorine), which not only dissolves the lithium salt so that the electrolyte has lithium-ion conductivity, but also plays a role of leaching sulfur, which is a positive electrode active material, so that the electrochemical reaction with lithium can proceed smoothly.

Specific examples of the glyme-based compound may be, but are not limited to, at least one selected from the group consisting of dimethoxyethane, diethoxyethane, methoxyethoxyethane, diethylene glycol dimethyl ether, diethylene glycol diethyl ether, diethylene glycol methylethyl ether, triethylene glycol dimethyl ether, triethylene glycol diethyl ether, triethylene glycol methylethyl ether, tetraethylene glycol dimethyl ether, tetraethylene glycol diethyl ether, tetraethylene glycol methylethyl ether, polyethylene glycol dimethyl ether, polyethylene glycol diethyl ether, and polyethylene glycol methylethyl ether, and among them, it is preferable to use dimethoxyethane.

The lithium salt is an electrolyte salt used to increase ion conductivity, and may be used without limitation as long as it is commonly used in the art. Specific examples of the lithium salt may be at least one from the group consisting of LiCl, LiBr, LiI, LiClO₄, LiBF₄, LiBioClio, LiPF₆, LiCF₃SO₃, LiCF₃CO₂, LiC₄BO₈, LiAsF₆, LiSbF₆, LiAlCl₄, CH₃SO₃Li, CF₃SO₃Li, (CF₃SO₂)₂NLi, (C₂F₅SO₂)₂NLi, (SO₂F)₂NLi, (CF₃SO₂)₃CLi, lithium chloroborane, lithium lower aliphatic carboxylic acid having 4 or less carbon atoms, lithium tetraphenyl borate, and lithium imide.

The concentration of the lithium salt may be determined in consideration of ion conductivity and the like, and may be, for example, 0.1 to 2 M, preferably 0.5 to 1 M, and more preferably 0.5 to 0.75 M. If the concentration of the lithium salt is less than the range above, it is difficult to ensure ion conductivity suitable for operating the battery. If the concentration of the lithium salt exceeds the range above, the viscosity of the electrolyte is increased, so that the mobility of lithium ions is deteriorated, or the decomposition reaction of the lithium salt itself is increased, thereby deteriorating the performance of the battery.

In the electrolyte containing the first solvent, the second solvent and the lithium salt as described above, the molar ratio of the lithium salt, the second solvent, and the first solvent may be 1:0.5 to 3:4.1 to 15. In addition, in one embodiment of the present disclosure, the electrolyte comprised in the lithium-sulfur battery of the present disclosure contains the first solvent containing a fluorine-based ether compound in a higher content ratio compared to a second solvent containing a glyme-based compound, for example, the molar ratio of the lithium salt, the second solvent and the first solvent may be 1:2:4 to 13, 1:3:3 to 10, or 1:4:5 to 10. As such, if the first solvent containing a fluorine-based ether compound is contained in a higher content ratio than the second solvent containing a glyme-based compound, since it is possible to realize the capacity of the battery close to the theoretical capacity of sulfur by suppressing the generation of the polysulfide and there is an advantage in suppressing the decrease in the capacity of the battery due to the use of the battery, it is preferable to set it so that the first solvent containing a fluorine-based ether compound is comprised in a higher content ratio compared to the second solvent containing a glyme-based compound.

The negative electrode comprised in the lithium-sulfur battery of the present disclosure is a lithium-based metal, and may further comprise a current collector on one side of the lithium-based metal. As the current collector, a negative electrode current collector may be used. The negative electrode current collector is not particularly limited as long as it has high electrical conductivity without causing chemical changes in the battery. The negative electrode current collector may be selected from the group consisting of copper, aluminum, stainless steel, zinc, titanium, silver, palladium, nickel, iron, chromium, alloys thereof, and combinations thereof. The stainless steel may be surface treated with carbon, nickel, titanium, or silver. As the alloy, an aluminum-cadmium alloy may be used, and in addition, calcined carbon, a non-conductive polymer surface-treated with an electrically conductive material, or an electrically conductive polymer may be used. In general, a thin copper plate is applied as the negative electrode current collector.

In addition, the shape of the negative electrode current collector can be various forms such as a film having or not having fine irregularities on its surface, sheet, foil, net, porous body, foam, nonwoven fabric and the like. In addition, the thickness of the negative electrode current collector is in the thickness range of 3 to 50 μm. If the thickness of the negative electrode current collector is less than 3 μm, the current collecting effect is lowered. On the other hand, if the thickness exceeds 50 μm, when folding and then assembling the cell, there is a problem that the workability is reduced.

The lithium-based metal may be lithium or a lithium alloy. In that case, the lithium alloy contains an element capable of alloying with lithium, and specifically the lithium alloy may be an alloy of lithium and at least one selected from the group consisting of Si, Sn, C, Pt, Ir, Ni, Cu, Ti, Na, K, Rb, Cs, Fr, Be, Mg, Ca, Sr, Sb, Pb, In, Zn, Ba, Ra, Ge and Al.

The lithium-based metal may be in the form of a sheet or foil, and in some cases, may be in a form in which lithium or a lithium alloy is deposited or coated on a current collector by a dry process, or may be in a form in which metal and an alloy in a particle phase are deposited or coated by a wet process or the like.

A conventional separator may be disposed between the positive electrode and the negative electrode. The separator is a physical separator having a function of physically separating the electrodes, and can be used without a particular limitation as long as it is used as a conventional separator, and particularly, a separator with low resistance to ion migration in the electrolyte solution and excellent impregnating ability for the electrolyte solution is preferable.

In addition, the separator enables the transport of lithium ions between the positive electrode and the negative electrode while separating or insulating the positive electrode and the negative electrode from each other. The separator may be made of a porous, nonconductive, or insulating material. The separator may be an independent member such as a film or a coating layer added to the positive electrode and/or the negative electrode.

Examples of the polyolefin-based porous film which can be used as the separator may be films formed of any polymer alone selected from polyethylene such as high-density polyethylene, linear low-density polyethylene, low-density polyethylene, and ultra-high molecular weight polyethylene, and polyolefin-based polymers such as polypropylene, polybutylene, and polypentene, or formed of a polymer mixture thereof. Examples of the nonwoven fabric that can be used as the separator is a nonwoven fabric formed by a polymer of polyphenyleneoxide, polyimide, polyamide, polycarbonate, polyethyleneterephthalate, polyethylenenaphthalate, polybutyleneterephthalate, polyphenylenesulfide, polyacetal, polyethersulfone, polyetheretherketone, polyester and the like alone or a mixture thereof. Such nonwoven fabrics include a nonwoven fabric in the form of a fiber to form a porous web, that is, a spun-bond or a melt-blown nonwoven fabric composed of long fibers.

The thickness of the separator is not particularly limited, but is preferably in the range of 1 to 100 μm, more preferably 5 to 50 μm. If the thickness of the separator is less than 1 μm, the mechanical properties cannot be maintained. If the thickness of the separator exceeds 100 μm, the separator acts as a resistive layer, thereby deteriorating the performance of the battery. A pore size and porosity of the separator are not particularly limited, but it is preferable that the pore size is 0.1 to 50 μm and the porosity is 10 to 95%. If the separator has a pore size of less than 0.1 μm or a porosity of less than 10%, the separator acts as a resistive layer. If the separator has a pore size exceeding 50 μm or a porosity exceeding 95%, mechanical properties cannot be maintained.

The lithium-sulfur battery of the present disclosure comprising the positive electrode, the negative electrode, the separator, and the electrolyte, as described above can be manufactured through a process of facing the positive electrode with the negative electrode, interposing the separator between them, and then injecting the electrolyte solution.

On the other hand, the lithium-sulfur battery according to the present disclosure is applied to a battery cell used as a power source for a small device, and can be also particularly suitably used as a unit cell for a battery module, which is a power source for medium and large-sized devices. In this aspect, the present disclosure also provides a battery module comprising two or more lithium-sulfur batteries electrically connected (series or parallel). Of course, the quantity of lithium-sulfur batteries comprised in the battery module may be variously adjusted in consideration of the use and capacity of the battery module. Furthermore, the present disclosure provides a battery pack in which the battery modules are electrically connected according to a conventional technique in the art. The battery module and the battery pack may be used as a power source for any one or more medium and large-sized devices among a power tool; electric vehicles including electric vehicle (EV), a hybrid electric vehicle (HEV), and a plug-in hybrid electric vehicle (PHEV); electric truck; electric commercial vehicles; or power storage systems, but are not limited thereto. However, it may be preferable that the lithium-sulfur battery of the present disclosure is a battery for an aircraft used as an urban air mobility (UAM).

Hereinafter, preferred examples are presented to aid understanding of the present disclosure, but the following examples are merely illustrative of the present disclosure, and it is obvious to those skilled in the art that various changes and modifications are possible within the scope and spirit of the present disclosure, and it goes without saying that that these changes and modifications fall within the scope of the appended claims.

### [Examples 1 to 8, Comparative Examples 1 to 4] Preparation of Porous Carbon Material

A porous carbon material was put into a glass jar, and then nitrogen gas was injected to perform purging for 1 minute. Subsequently, microwaves were irradiated on the porous carbon material. In this case, the porous carbon materials used in Examples 1 to 8 and Comparative Examples 1 to 4 were as follows. In addition, the microwave energy value (MPPT) received by each unit carbon material used in Examples 1 to 8 and Comparative Examples 1 to 4 is shown in Table 1 below.

TABLE 1

| | Carbon material | MPPT(W · s/g) |
|---|---|---|
| Example 1 | carbon nanotube | 2,160 |
| Example 2 | multilayer graphene flake | 3,600 |
| Example 3 | carbon black | 3,120 |
| Example 4 | Ketjen black | 6,480 |
| Example 5 | carbon nanotube | 2,880 |
| Example 6 | multilayer graphene flake | 5,400 |
| Example 7 | carbon black | 3,600 |
| Example 8 | Ketjen black | 9,980 |
| Comparative Example 1 | carbon nanotubes | 1,440 |
| Comparative Example 2 | multilayer graphene flake | 1,800 |
| Comparative Example 3 | carbon black | 1,680 |
| Comparative Example 4 | Ketjen black | 12,960 |
| Comparative Example 5 | carbon nanotube | — |

Example 1, Example 5, Comparative Example 1: carbon nanotubes having specific surface area of 270 m²/g
Example 2, Example 6, Comparative Example 2: multilayer graphene flake having specific surface area of 1,600 m²/g
Example 3, Example 7, Comparative Example 3: carbon black having specific surface area of 1,550 m²/g
Example 4, Example 8, Comparative Example 4: Ketjen black having specific surface area of 1,350 m²/g.

### [Comparative Example 5] Porous Carbon Material

Carbon nanotubes with a specific surface area of 270 m²/g identical to those used in Example 1, Example 5 and Comparative Example 1 were prepared. That is, unlike Examples 1 to 8 and Comparative Examples 1 to 4, the carbon material was not irradiated with microwaves.

### [Experimental Example 1] Evaluation of the Removal Rate of Impurities Contained in Porous Carbon Material

The amount of impurities removed from each of the porous carbon materials prepared in Examples 1 to 8 and Comparative Examples 1 to 4 was measured, and the results are shown in Table 2 below. That is, it was confirmed how much the impurities contained in the carbon material were reduced after irradiating the microwaves. In addition, a precision balance (Model: ML204T/00, Manufacturer: Mettler Toledo) having a measurement unit of 0.1 mg was used for the measurement.

TABLE 2

| | | | Ratio of amount of impurities removed | |
|---|---|---|---|---|
| | | MPPT | based on the total weight of carbon | |
| | Carbon material | (W · s/g) | material (impurity removal rate) | |
| Example 1 | carbon nanotubes | 2,160 | 5 wt. % | (100%) |
| Example 2 | multilayer graphene flake | 3,600 | 5 wt. % | (100%) |
| Example 3 | carbon black | 3,120 | 2.7 wt. % | (100%) |
| Example 4 | Ketjen black | 6,480 | 3 wt. % | (100%) |
| Example 5 | carbon nanotube | 2,880 | 5 wt. % | (100%) |
| Example 6 | multilayer graphene flake | 5,400 | 5 wt. % | (100%) |
| Example 7 | carbon black | 3,600 | 2.7 wt. % | (100%) |
| Example 8 | Ketjen black | 9,980 | 3 wt. % | (100%) |
| Comparative | carbon nanotube | 1,440 | 4 wt. % | (80%) |
| Example 1 | | | | |
| Comparative | multilayer graphene flake | 1,800 | 2.5 wt. % | (50%) |
| Example 2 | | | | |
| Comparative | carbon black | 1,680 | 2 wt. % | (74%) |
| Example 3 | | | | |
| Comparative | Ketjen black | 12,960 | 3 wt. % (100%), occurrence | |
| Example 4 | | | of ignition phenomena | |
| Comparative | carbon nanotube | — | 0 wt. % | (0%) |
| Example 5 | | | | |

As a result of measuring the amount of impurities removed from each of the porous carbon materials prepared in Examples 1 to 8 and Comparative Examples 1 to 4 as described above, as shown in Table 1, it was confirmed that the impurities are completely removed from the porous carbon materials of Examples 1 to 8, where the microwave energy value received by the unit carbon material is set to 2,000 to 10,000 W·s/g. On the other hand, it was confirmed that the impurities are not sufficiently removed from the porous carbon materials of Comparative Examples 1 to 3, where the microwave energy value received by the unit carbon material is set to less than 2,000 W·s/g. In addition, in the case of Comparative Example 4, where the microwave energy value received by the unit carbon material was set to exceed 10,000 W·s/g, the impurities were completely removed as in Examples 1 to 8, but an ignition phenomenon was also occurred.

### [Experimental Example 2] Confirmation of Whether Impurities are Removed Through Thermal Gravimetric Analysis (TGA)

In order to check whether the impurities have been removed from the porous carbon material manufactured in Example 1 above, TGA analysis (the temperature increase condition (R.T˜500° C.) of 10° C./min, nitrogen atmosphere) was performed with the porous carbon material (not microwave-treated) of Comparative Example 5.

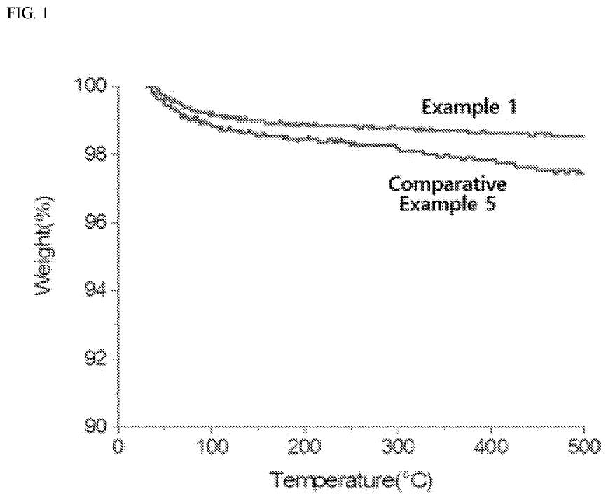

FIG. 1 is a graph of TGA analysis for checking whether impurities are removed from the porous carbon materials according to an embodiment of the present disclosure and a comparative example. As a result of TGA analysis of the porous carbon material prepared in Example 1 and the porous carbon material of Comparative Example 5, it was confirmed that in the case of the porous carbon material of Example 1 where the microwave energy value received by the unit carbon material is set to 2,000 to 10,000 W·s/g, the weight loss due to the increase in temperature is significantly smaller than that of the porous carbon material in Comparative Example 5 which is not irradiated with microwaves, as shown in FIG. 1. Accordingly, it can be seen that if a microwave energy value of 2,000 to 10,000 W·s/g is given to the porous carbon material, impurities such as moisture are removed (meanwhile, the reason for the decrease in weight from FIG. 1 to 100° C. is due to absorption of moisture during storage of the carbon material).

### [Experimental Example 3] Confirmation of Whether Impurities are Removed Through Elemental Analysis (EA)

In order to check whether the impurities have been removed from the porous carbon material prepared in Example 1, EA analysis was performed with an elemental analyzer (Model name: Flash 2000, Manufacturer: Thermo Scientific™) along with the porous carbon material (not microwave-treated) of Comparative Example 5, and the results are shown in Table 3 below.

TABLE 3

| | Example 1 | Comparative Example 5 |
|---|---|---|
| C | 98 | 93.6 |
| H | <1 | <1 |
| N | — | <1 |
| O | <1 | 1.5 |

As a result of EA analysis of the porous carbon material prepared in Example 1 and the porous carbon material of Comparative Example 5, it was confirmed that in the case of the porous carbon material of Example 1 where the microwave energy value received by the unit carbon material is set to 2,000 to 10,000 W·s/g, the content of carbon (C) is increased due to the removal of the impurities such as moisture.

### [Comparative Example 6] Preparation of Sulfur-Carbon Composite

A sulfur-carbon composite was prepared by mixing the carbon nanotubes of Comparative Example 5 that were not microwave-treated and sulfur (S) at a weight ratio of 75:25, and then drying them. Subsequently, the prepared sulfur-carbon composite was placed in a glass jar, and then microwaves were irradiated (MPPT: 2,160 W·s/g) in the state where nitrogen gas was injected and purged for 1 minute.

### [Experimental Example 4] Evaluation of Temperature Profile According to Microwave Irradiation Time

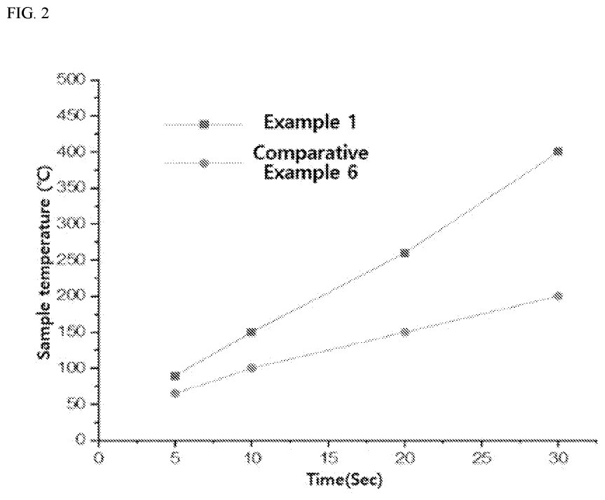

While irradiating microwaves (MPPT: 2,160 W·s/g) on the porous carbon material prepared in Example 1 and the sulfur-carbon composite prepared in Comparative Example 6, the temperature over time was measured with a thermocouple (306 data logger, Conrad Electronics, Hirschau, Germany), respectively, and the results are shown in FIG. 2. FIG. 2 is a graph showing the temperature profile over time when irradiating microwaves under the same conditions on porous carbon material and sulfur-carbon composite.

As a result of measuring the temperature in units of 5 seconds while irradiating microwaves on the porous carbon material of Example 1 and the sulfur-carbon composite of Comparative Example 6, it was confirmed that the temperature increase rate of the porous carbon material (Example 1) is very fast compared to that of the sulfur-carbon composite (Comparative Example 6), as shown in FIG. 2. In other words, when the microwaves were irradiated, the temperature increase rate of carbon is faster than that of sulfur, and thus the temperature of carbon rises first, and the energy generated when the temperature of carbon rises is transferred to sulfur and converted into energy for vaporization of sulfur. At this time, sulfur is vaporized from a low temperature before impurities contained in carbon are removed.

In other words, when microwaves are irradiated under the same MPPT conditions, in the case of the porous carbon material (Example 1), the temperature rises to about 400° C. based on the time point after 30 seconds of microwave irradiation, and the impurities in the carbon material are removed. On the other hand, the sulfur-carbon composite (Comparative Example 6) rises to about 200° C. (the temperature at which the volatilization of sulfur rapidly occurs) based on the time point after 30 seconds of microwave irradiation, and the impurities in the carbon material are volatilized together with sulfur. Therefore, when microwaves are applied to the sulfur-carbon composite (Comparative Example 6) itself, it is not only impossible to selectively remove only the impurities in the carbon material, but rather causes loss of sulfur, which inevitably adversely affects the performance of the battery. Therefore, it can be seen that even if microwaves are applied to the carbon material, the object of the present disclosure can be achieved only when applied only to the carbon material itself, not in a state in which it is composited with sulfur.

### [Experimental Example 5] Thermogravimetric Analysis (TGA)

In Experimental Example 2, it was confirmed that the impurities such as moisture are removed from the porous carbon material of Example 1 through thermogravimetric analysis (TGA). Also, for comparison and contrast with this, TGA analysis (the temperature increase condition (R.T˜500° C.) of 10° C./min, nitrogen atmosphere) was also performed with the sulfur-carbon composite of Comparative Example 6.

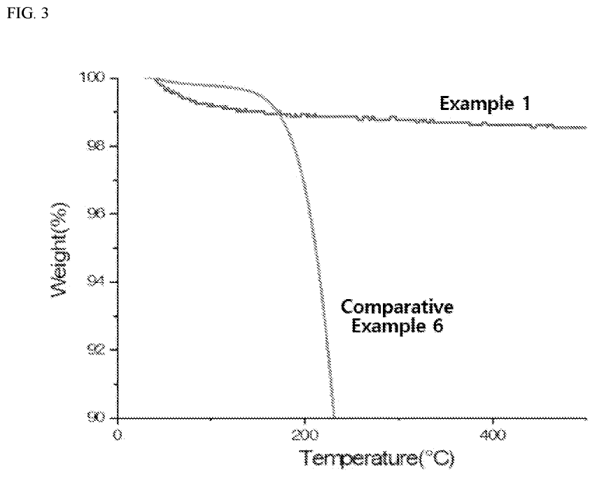

FIG. 3 is a graph of TGA analysis showing the degree of the decrease in weight due to temperature increase by performing TGA analysis on a porous carbon material according to an embodiment of the present disclosure and a sulfur-carbon composite according to a comparative example. As a result of TGA analysis of the porous carbon material of Example 1 and the sulfur-carbon composite of Comparative Example 6, it can be seen that in the case of the porous carbon material in Example 1, the decrease in weight due to temperature increase is significantly smaller than that of the sulfur-carbon composite in Comparative Example 6, as shown in FIG. 3. This is due to the fact that even if the microwaves are irradiated on the porous carbon material (Example 1) and the sulfur-carbon composite (Comparative Example 6) under the same MPPT conditions, in the case of the sulfur-carbon composite (Comparative Example 6), the impurities in the carbon material are volatilized with sulfur, as described in Experimental Example 4.

That is, it can be seen even through the results of this experiment that it is not only impossible to selectively remove only the impurities contained in the carbon material in the sulfur-carbon composite, but rather causes loss of sulfur, which inevitably adversely affects the performance of the battery. Therefore, it can be seen that even if microwaves are applied to the carbon material, the object of the present disclosure can be achieved only when applied only to the carbon material itself, not in a state in which it is composited with sulfur.

1. A porous carbon material with a specific surface area of 200 to 1,700 m²/g, from which impurities were removed through pre-treatment using microwaves.

2. The porous carbon material according to claim 1, wherein, during the pre-treatment using the microwaves, the microwaves are applied to the porous carbon material under a condition that MPPT according to the following Equation 1 is 2,000 to 10,000 W·s/g:
MPPT (W·s/g)=Microwave Power(W)×Time(s)/Weight of carbon material (g) [Equation 1]
wherein Time is a period of time in seconds during which the microwaves are applied, and is longer than 10 seconds.

3. The porous carbon material according to claim 2, wherein the porous carbon material is selected from the group consisting of carbon nanotubes; graphene which is a multilayer graphene flake, MGF; graphite; carbon black selected from the group consisting of carbon black, acetylene black, Ketjen black, Denka black, thermal black, channel black, furnace black and lamp black; carbon fiber; and a mixture containing two or more thereof.

4. The porous carbon material according to claim 3, wherein the porous carbon material is selected from the group consisting of carbon nanotubes, graphene, carbon black and Ketjen black.

5. The porous carbon material according to claim 1, wherein a pore volume of the porous carbon material is 1.5 cm³/g or more.

6. The porous carbon material according to claim 1, from which 90 to 100% of the total impurities contained therein have been removed.

7. The porous carbon material according to claim 6, from which 99 to 100% of the total impurities contained therein have been removed.

8. The porous carbon material according to claim 1, wherein the impurities comprise moisture and functional groups present in an inside and on a surface of the porous carbon material.

9. A method for preparing a porous carbon material from which impurities have been removed, the method comprising:
(a) putting a porous carbon material having a specific surface area of 200 to 1,700 m²/g into an airtight container, and then purging the airtight container with an inert gas by injecting the inert gas; and
(b) applying microwaves to the porous carbon material.

10. The method according to claim 9, wherein, in step (b), the microwaves are applied to the porous carbon material under a condition that MPPT according to the following Equation 1 is 2,000 to 10,000 W·s/g:
MPPT(W·s/g)=Microwave Power(W)×Time(s)/Weight of carbon material(g) [Equation 1]
wherein Time is a period of time in seconds during which the microwaves are applied, and is longer than 10 seconds.

11. A positive electrode for a lithium-sulfur battery, the positive electrode comprising a sulfur-carbon composite in which sulfur is supported in the porous carbon material of claim 1 as a positive electrode active material.

12. The positive electrode according to claim 11, wherein there is no error in a content of sulfur and carbon material contained in the positive electrode active material.

13. A lithium-sulfur battery comprising the positive electrode of claim 11; a negative electrode; a separator between the positive electrode and the negative electrode; and an electrolyte comprising a first solvent containing a fluorine-based ether compound, a second solvent containing a glyme-based compound, and a lithium salt.

14. The lithium-sulfur battery according to claim 13, wherein a utilization rate of sulfur contained in the positive electrode is 90% or more of the theoretical discharging capacity.

15. The lithium-sulfur battery according to claim 13, wherein an energy density of the lithium-sulfur battery is 400 Wh/kg or more or 600 Wh/L or more.
